(19) United States
(12) Patent Application Publication
(10) Pub. No.: US 2024/0360384 A1
(43) Pub. Date: Oct. 31, 2024

(54) RAIN-ACTIVATED VEHICLE CLEANING COMPOSITION

(71) Applicant: Bike Brite, Inc., CLEVELAND, OH (US)

(72) Inventors: Joseph C. Coviello, CLEVELAND, OH (US); Maria I. Coviello, CLEVELAND, OH (US)

(21) Appl. No.: 18/644,215

(22) Filed: Apr. 24, 2024

Related U.S. Application Data
(60) Provisional application No. 63/461,676, filed on Apr. 25, 2023.

(51) Int. Cl. C11D 3/00

(52) U.S. Cl. CPC C11D 3/0047; C11D 3/0094; C11D 2111/14; C11D 2111/42

(57) ABSTRACT

Disclosed is a cleaning composition, and methods of use and processes thereof. The cleaning composition may be used for cleaning surfaces, such as an exterior of a vehicle. The cleaning composition can interact with rain, or other source of water, to provide cleaning of the surfaces. The cleaning composition can interact with, attach to, or bond to salt, dirt, grime, oils, and the like, on the surface of a vehicle, for example, and can then gently wash the particles away using rain as a rinsing agent. The cleaning composition may include a chelating agent and a surfactant. The cleaning composition may be pH-controlled and can act as a neutralizer to the acidity in rain or other water to provide cleaning of the applied surfaces.

### CROSS REFERENCE TO RELATED APPLICATIONS

The application claims priority to U.S. Patent Application No. 63/461,676, filed on Apr. 25, 2023, entitled “RAIN-ACTIVATED VEHICLE CLEANING COMPOSITION,” which is incorporated herein by reference in its entirety.

### FIELD OF THE INVENTION

The present disclosure relates generally to cleaning compositions and, more particularly, to cleaning compositions for use on surfaces such as an exterior of a vehicle and that are configured to interact with rain, or other source of water, to provide cleaning of the surfaces, and methods of use and processes thereof.

### BACKGROUND

With increasing threats to community water supplies, extended droughts, and continuing climate change, water scarcity and water security are becoming critical issues. For example, as of March 2023, about 21% of the contiguous U.S. were classified as experiencing moderate to extreme drought according to the Palmer Drought Index. Even as 9% of the contiguous U.S. fell into the severely to extremely wet categories in the same time frame, including in areas such as California that had been experiencing drought conditions prior, the additional rain has not been enough to replenish the water in the critical reservoirs, basins, and aquifers that supply water to local communities and that generate hydropower electricity.

In response, states often implement restrictions on community and individual water usage and more recently, the U.S. federal government has proposed water supply restrictions to states that depend on the Colorado River Basin, for example. The Colorado River Basin supplies water to seven states and more than 40 million Americans, irrigates 5.5 million agricultural acres, and generates hydropower electricity for millions of homes and businesses. This water supply, and the people it services, is currently at risk. Additionally, only 2.5% of the world's water is fresh water, the majority of which is inaccessible as ice, leaving approximately 1.2% of fresh water to available for use. Fresh water is an increasingly scarce resource.

With many water protections already implemented and more to be expected, individuals, communities, and states may anticipate being under water restrictions at one time or another regardless of current rainfall or precipitation in the area. Generally, individuals and businesses hoping to limit their carbon footprint or being mindful of their climate impact may choose to limit their water usage even if not mandated. Such actions may also provide significant cost savings as water access becomes more expensive. As a result, water conservation efforts can be expected to increase out of necessity and cost savings as well as the general desire to be more environmentally conscious. Such water conservation efforts will leave consumers looking for ways to minimize their water use.

Washing items and surfaces, such as vehicles, utilizes significant amounts of water. A single at-home car wash may use over to 100 gallons of water depending on the size of the vehicle and amount of dirt and grime accumulated on the surface. Commercial car washes may use an average of 40-80 gallons of fresh water to wash each car, but are estimated to wash up to 8 million cars each day, which, even by conservative estimates, can amount to hundreds of millions of gallons of water used per day washing vehicles.

Similarly, airplanes also require significant amounts of water for washing and about 3000 gallons of water for an average sized plane. With approximately 25,000 airplanes in the air every day being washed every 2-6 months, one cycle of washing can amount to tens of millions of gallons of water used. Due to the size of the aircraft bodies, rinsing can require spraying upward from a source of water, such as a hose, so that there is also a loss or waste of water before it is able to reach the aircraft body. Washing an airplane can also result in other related expenses, such as having to take the airplane out of service for 1 or more days and provide a crew of several workers. Clean aircraft bodies can also be important for maintenance and visual inspection of the airplanes.

Generally, regular washing of vehicles, airplanes, and other exterior surfaces that may face weather conditions may be important to protect the surfaces from harsh conditions and the damage that dust and grime can cause if left on the surfaces for prolonged periods of time. Washing can extend the life of the items and help to preserve the finish of the surfaces.

Rain itself or with conventional soaps may not be effective at providing desired cleaning of the exposed or applied surfaces, and may result in water spots, uncleaned areas, and the like. In fact, after having just cleaned a vehicle or other surface, rain is usually avoided as it can “dirty” up the cleaned surface. Generally, rain risks undoing any cleaning that may have been done since the surface will be dirtied by exposure to the rain. Additionally, rain and other inclement weather generally prevents individuals from cleaning surfaces that are outside.

As a result, there is a need for improved cleaning compositions and methods that can minimize the use or amount of fresh water. There is a need for improved cleaning compositions and methods that can provide one or more (or all) of the following: reduced fresh water consumption, reduced expenses, reduced effort or time spent cleaning, satisfactory or enhanced cleaning effects, resistance against the accumulation of dirt and grime following cleaning, cleaning and protection of surfaces, and the like. There is a need for cleaning compositions and methods that use rain, cleaning compositions that can be used during rain, cleaning compositions that leave a surface cleaner after it rains, and the like.

### SUMMARY

The following presents a summary of the disclosure to provide a basic overview and understanding of some aspects. This summary is intended to neither identify key or critical elements nor define any limitations of embodiments or claims. This summary may provide a simplified overview of aspects that may be described in greater detail in other portions of this disclosure. Any of the described aspects may be isolated or combined with other described aspects without limitation and to the same effect as if they had been described separately and in every possible combination explicitly.

Disclosed are cleaning compositions and methods that can minimize the use or amount of fresh water. The disclosed cleaning compositions and methods can provide one or more (or all) of the following: reduced fresh water consumption, reduced expenses, reduced effort or time spent cleaning, satisfactory or enhanced cleaning effects, resistance against the accumulation of dirt and grime following cleaning, cleaning and protection of surfaces, and the like. The disclosed cleaning compositions and methods may use rain, can be used during rain, may leave a surface cleaner after it rains, and the like.

Disclosed is a cleaning composition, and methods of use and processes thereof. The cleaning composition may be used for cleaning surfaces, such as an exterior of a vehicle. The cleaning composition can interact with rain, or other source of water, to provide cleaning of the surfaces. The cleaning composition can interact with, attach to, or bond to salt, dirt, grime, oils, and the like, on the surface of a vehicle, for example, and can then gently wash the particles away using rain as a rinsing agent. The cleaning composition may include a chelating agent and a surfactant. The cleaning composition may be pH-controlled and can act as a neutralizer to the acidity in rain or other water to provide cleaning of the applied surfaces.

Disclosed is a cleaning composition. In an embodiment, the cleaning composition may comprise a chelating agent. In an embodiment, the cleaning composition may comprise a surfactant. In an embodiment, the cleaning composition may be applicable to a surface. In an embodiment, the cleaning composition may be configured to interact with water having a first pH, In an embodiment, the cleaning composition may be configured to increase the first pH of the water to a second pH.

In an embodiment, the water may be rain. In an embodiment, the cleaning composition may be configured to be used during or just preceding rain. In an embodiment, the cleaning composition may not require additional rinsing or water source. In an embodiment, the cleaning composition may have a basic pH. In an embodiment, the cleaning composition may have a neutral or basic pH. In an embodiment, the cleaning composition may have a pH of 7 or greater. In an embodiment, the cleaning composition may have a pH range of 7 to 7.8. In an embodiment, a pH of the cleaning composition may be more basic than the first pH of the water. In an embodiment, the first pH may be more acidic than the second pH. In an embodiment, the first pH may be between 4 to 6. In an embodiment, the second pH may be between 6 to 7. In an embodiment, the second pH may have a pH of soft water. In an embodiment, the cleaning composition may further include a foam booster. In an embodiment, the cleaning composition may further include a purified water.

Disclosed is a rain-activated cleaning composition. In an embodiment, the rain-activated cleaning composition may comprise at least one chelating agent, at least one surfactant, a foam booster, and purified water. In an embodiment, the rain-activated cleaning composition may have a neutral or basic pH. In an embodiment, the rain-activated cleaning composition may be configured to be applied to an exterior surface of a vehicle. In an embodiment, the rain-activated cleaning composition may be configured to react with rain to clean the exterior surface of the vehicle. In an embodiment, the rain-activated cleaning composition may be configured to interact with rain to make the rain less acidic.

Disclosed is a method of using a rain-activated cleaning composition. In an embodiment, the method may comprise applying the rain-activated cleaning composition to an exterior surface. In an embodiment, the cleaning composition may be configured to interact with rain having a first pH. In an embodiment, the cleaning composition may be configured to raise the first pH of the rain to a second pH. In an embodiment, the cleaning composition may be configured to interact with the rain to lift contaminants from the surface. In an embodiment, the cleaning composition may be configured to be rinsed away by the rain with the contaminants.

The following description and the drawings disclose various illustrative aspects. Some improvements and novel aspects may be expressly identified, while others may be apparent from the description and drawings.

### BRIEF DESCRIPTION OF THE DRAWINGS

The present teachings may be better understood by reference to the following detailed description taken in connection with the following illustrations. The accompanying drawings illustrate various systems, apparatuses, devices, and methods, in which like reference characters refer to like parts throughout, which:

FIG. 1 shows an embodiment of a method of using a cleaning composition in accordance with aspects disclosed herein; and

FIG. 2 shows an embodiment of a method of using a cleaning composition in accordance with aspects disclosed herein.

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION

Reference will now be made in detail to exemplary embodiments of the present teachings, examples of which are illustrated in the accompanying drawings, wherein like numbered aspects refer to a common feature throughout. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and still be within the spirit and scope of the present teachings.

In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Disclosed is a cleaning composition, and methods of use and processes thereof. The cleaning composition may be used for cleaning surfaces, such as an exterior of a vehicle. The cleaning composition can interact with rain, or other source of water, to provide cleaning of the surfaces. The cleaning composition can interact with, attach to, or bond to salt, dirt, grime, oils, and the like, on the surface of a vehicle, for example, and can then gently wash the particles away using rain as a rinsing agent. The cleaning composition may include a chelating agent and a surfactant. The cleaning composition may be pH-controlled and can act as a neutralizer to the acidity in rain or other water to provide cleaning of the applied surfaces. The cleaning composition may use natural rain to clean and wash a vehicle. The cleaning composition may be applied as a spray to a vehicle's exterior.

The cleaning composition may apply as a foam or foam-like substance to a vehicle's exterior. The cleaning composition may be sprayed onto a vehicle's exterior and the active ingredients in the composition can have time to interact with, attach to, or bond to the salt, dirt, grime, oils, and the like, that may be present on the surface of a vehicle. The cleaning composition can be used during rain and as it is raining. The cleaning composition may not require manual drying. The foam mixed with the rain can lift particles, e.g., dirt particles, from the surface of the vehicle and wash them away naturally. The cleaning composition can serve as a bonding agent between the particles and water from the rain.

In an embodiment, the cleaning composition one or more (or all) of the following: a chelating agent, a surfactant, a foam booster, and purified water. In an embodiment, the cleaning composition may include at least one of each of the following: a chelating agent, a surfactant, a foam booster, and purified water. In an embodiment, the cleaning composition may include only one or more chelating agents, surfactants, foam boosters, and purified water. In an embodiment, the cleaning composition may include a chelating agent. In an embodiment, the cleaning composition may include a surfactant. In an embodiment, the cleaning composition may include a chelating agent. In an embodiment, the cleaning composition may include a chelating agent and a surfactant. It is noted that other compositions and combinations of the foregoing are also contemplated herein and comprise a part of this disclosure.

In an embodiment, the cleaning composition may be pH-controlled. In an embodiment, the cleaning composition can act as a neutralizer to the acidity in rain or other water. The neutralization of the cleaning composition may provide cleaning of the applied surfaces. In an embodiment, the cleaning composition may have a basic pH. In an embodiment, the cleaning composition may have a neutral pH. In an embodiment, the cleaning composition may have a pH of approximately 7 or greater (e.g., at least approximately 7 pH). In an embodiment, the cleaning composition may have a pH of approximately 7.8 or greater (e.g., at least approximately 7.8 pH). In an embodiment, the cleaning composition may have a pH range of approximately 7 up to and including 8 (e.g., an approximate range of 7 to 8 pH). In an embodiment, the cleaning composition may have a pH range of approximately 7 up to and including 7.8 (e.g., an approximate range of 7 to 7.8 pH). In an embodiment, the cleaning composition may have a pH range of approximately 7.8 up to and including 8 (e.g., an approximate range of 7.8 to 8 pH).

In an embodiment, the cleaning composition may have a pH that can neutralize the acidity in rain so that the rain and/or the combined solution of the cleaning composition and the rain have a neutral pH. In an embodiment, the cleaning composition may have a pH that can neutralize the acidity in rain so that the rain and/or the combined solution of the cleaning composition and the rain have a basic pH. In an embodiment, the cleaning composition may have a pH that can neutralize the acidity in rain so that the rain and/or the combined solution of the cleaning composition and the rain have a pH that is more basic or less acidic than rain alone. In an embodiment, the cleaning composition may have a pH that can neutralize the acidity in rain so that the rain and/or the combined solution of the cleaning composition and the rain have a pH range of approximately 6 up to and including 7 (e.g., an approximate range of 6 to 7 pH). In an embodiment, the cleaning composition may have a pH that can neutralize the acidity in rain so that the rain and/or the combined solution of the cleaning composition and the rain have a pH of approximately 6 or greater (e.g., at least approximately 6 pH). In an embodiment, the cleaning composition may have a pH that can neutralize the acidity in rain so that the rain and/or the combined solution of the cleaning composition and the rain have pH near or of soft water.

It is noted that references to the pH of “rain” or modified rain may generally refer to the pH of rain including the cleaning composition, rain after becoming mixed with the cleaning composition, and/or rain after interacting with the cleaning composition unless context or this disclosure suggests otherwise. It is noted that natural rain (e.g., not including, mixing, or interacting with the cleaning composition) is generally acidic and can range in pH from approximately 5 up to and including 5.8 pH, and can be as low as 3 pH in the cases of acid or acidic rain. It is noted that the terms “raising” or “increasing” the pH may be understood as making a composition more basic or less acidic. It is noted that the terms “lowering” or “decreasing” the pH may be understood as making a composition more acidic or less basic. It is noted that the term “approximately” is understood to include+/−0.2 all ranges and values herein described. It is noted that all described ranges and values herein are understood to include the beginning and end range values and all values therebetween, including decimals and the like.

While embodiments herein may describe use with rain, it is noted that other sources of water may also be used unless context or this disclosure suggests otherwise. While other sources may be used with the embodiments disclosed herein, it is noted that the cleaning composition may be formulated to control the pH of rain. It is noted that the cleaning composition may be formulated to control the pH of other water sources as may be desired.

While embodiments herein may describe use with exterior surfaces and vehicle surfaces, it is noted that the cleaning composition may be used with any surface unless context or this disclosure suggests otherwise. For example, the cleaning composition may be used with cars, trucks, vans, buses, boats, airplanes, and the like as well as outdoor furniture, building and house exteriors and windows, decks, barbecues, outdoor kitchens, patios, driveways, outdoor equipment and any other items or areas that may be exposed to dirt and grime outside or that may be desired to be cleaned with rain water.

The disclosed cleaning compositions may provide significant water savings and water conservation. For example, washing items and surfaces, such as vehicles, utilizes significant amounts of water. A single at-home car wash may use over to 100 gallons of water depending on the size of the vehicle and amount of dirt and grime accumulated on the surface. Commercial car washes may use an average of 40-80 gallons of fresh water to wash each car, but are estimated to wash up to 8 million cars each day, which, even by conservative estimates, can amount to hundreds of millions of gallons of water used per day washing vehicles. Similarly, airplanes also require significant amounts of water for washing and about 3000 gallons of water for an average sized plane. With approximately 25,000 airplanes in the air every day being washed every 2-6 months, one cycle of washing can amount to tens of millions of gallons of water used. Due to the size of the aircraft bodies, rinsing can require spraying upward from a source of water, such as a hose, so that there is also a loss or waste of water before it is able to reach the aircraft body. Washing an airplane can also result in other related expenses, such as having to take the airplane out of service for 1 or more days and provide a crew of several workers. Clean aircraft bodies can also be important for maintenance and visual inspection of the airplanes.

This water can be greatly minimized or eliminated by utilizing rain water for cleaning surfaces as an alternative. However, rain itself or with conventional soaps may not be effective at providing desired cleaning of the exposed or applied surfaces, and may result in water spots, uncleaned areas, and the like. Generally, regular washing of vehicles and other exterior surfaces that may face weather conditions may be important to protect the surfaces from harsh conditions and the damage that salt, dirt, grime, oils, and the like can cause if left on the surfaces' for prolonged periods of time. Salt, used by cities to combat icy and wintery road conditions, is known to cause corrosion on vehicles especially when left on the surface over time. Washing can extend the life of the items and help to preserve the finish of the surfaces. The cleaning composition can provide desired cleaning of surfaces without the use of fresh water.

Additionally, de-icing cannons may be used to apply the cleaning composition to an airplane while on the tarmac while raining. Hoses may be used to apply the cleaning composition to other exterior surfaces. Spray bottles may also be used for vehicles and other items.

In an embodiment, the cleaning composition may include at least one chelating agent or chelator. In an example, chelating agents may generally be classified as agents that can bond to or target heavy metal ions. The chelating agent may have specificity for ions or other components found in rain or other water sources. In an example, the chelating agent may have specificity to one or more (or all) of: sodium, potassium, magnesium, calcium, chloride, bicarbonate, and sulfate ions or ammonia, nitrate, nitrite, nitrogen, and other nitrogenous compounds. The chelating agent may prevent water spots by interacting with other components of the cleaning composition and/or components in rain or water.

Certain surfactants and detergents can be susceptible to the presence of metal cations in water, and the efficacy of the surfactants can be affected by binding of the metal cations. For example, the metal cations can reduce the surfactant's availability for micelle formation by causing the surfactant to precipitate out of the solution, for example. The chelating agent may prevent surfactant depletion. The chelating agent may be able to bind to the metal cations and keep them soluble while preventing the surfactants from binding to the metal cations. Non-limiting examples of chelating agents may include: tetra sodium EDTA, citric acid or salts thereof such as sodium citrate, sodium gluconate, phosphates, zeolite compounds, and polymeric compounds such as sodium polyacrylate.

In an embodiment, the composition may include a chemical or compound to help break the surface tension of water. In an embodiment, the cleaning composition may include a surfactant. The chemical, compound, or surfactant may make the cleaning composition easier to be washed off by rain. Non-limiting examples of surfactants may include: silicone surfactants, hydrocarbon surfactants, and perfluoro-surfactants.

In an embodiment, the cleaning composition may be pH-controlled. In an embodiment, the cleaning composition may be PH-balanced. The pH control of the cleaning composition may reduce the acidity of rain. For example, the cleaning composition may have a controlled pH slightly above neutral, such as a pH of approximately 7.8 up to and including 8. For example, the cleaning composition may have a pH that is not acidic. For example, the cleaning composition may have a pH that is not neutral or acidic. For example, the cleaning composition may have a pH that is neutral or basic. For example, the cleaning composition may have a pH that is basic. For example, the cleaning composition may have a pH of approximately 7.8 or greater.

Precipitation in the atmosphere may initially have a pH of approximately 6 up to and including 7, which may be considered soft water. As rain falls through the atmosphere, it may pick up carbon dioxide gas, which, in turn, can make the rain more acidic having a pH of approximately 4 up to and including 6. The exact pH and acidity of rain may depend on the amount of carbon dioxide or nitrogen oxides in the atmosphere. For example, rain may be more acidic in the city than out in the country.

In an embodiment, the cleaning composition can neutralize rain at any acidity level and can decrease the acidity in the rain by raising the pH so that it is soft water. The cleaning composition may thus turn rain into soft (or “softer”) water. The cleaning composition may utilize the modified rain water to wash off the product and the dirt, oil, and grime that the cleaning composition attached to, without leaving water residue. In an embodiment, the cleaning composition, rain, and combination thereof, having a pH of greater than approximately 6 or greater than approximately 7 may be desirable and the composition, having a controlled higher pH itself (e.g., higher than approximately 6 or higher than approximately 7), can modify acidic rain water to have a desired pH. For comparison, other conventional car washes may use water having a pH of approximately 7, which would not be able to neutralize the acidity in rain and therefore would not provide an effective cleaning composition as described. The cleaning composition as described may have an approximate pH greater than 7, which may allow it to neutrality the acidity in rain to a desired pH (such as a soft water pH of 6-7 for example), and provide improved cleaning.

In an embodiment, the cleaning composition may include a foam booster. The foam booster may assist in attaching to dirt and grime on the vehicle and assist in washing off easily upon rain. The foam booster may enable the cleaning composition to cling to the applied surfaces for a period of time to give time for the active ingredients of the cleaning composition to work.

The cleaning composition may include purified water. The purified water may ensure that no other chemicals are introduced into the cleaning composition that may interact with the other ingredients in the cleaning composition or affect efficacy of the cleaning composition.

In an embodiment, the cleaning composition may include one or more antimicrobial agents. In an embodiment, the cleaning composition may include other cleaners. In an embodiment, the cleaning composition may include degreasers. In an embodiment, the cleaning composition may include corrosive inhibitors. The corrosive inhibitors may extend the life of the vehicle and protect its exterior from corrosion. In an embodiment, the cleaning composition may include rust inhibitors. The rust inhibitors may extend the life of the vehicle and protect its exterior from rust. In an embodiment, the cleaning composition may include special brighteners. The brighteners may be used to paint surfaces to brighten or protect the painted surface. In an embodiment, the cleaning composition may include one or more protective agents. The protective agents may protect the applied surface. In an embodiment, the cleaning composition may include one or more hydrophobic agents. The hydrophobic agents may prevent water spots. In an embodiment, the cleaning composition may include one or more hydrophilic agents. The hydrophilic agents may assist in combining with the rain or water.

In an embodiment, the cleaning composition may be biodegradable. In an embodiment, the cleaning composition may mix or combine with the rain or water. In an embodiment, the cleaning composition may be diluted by the rain or water. For example, the cleaning composition may be applied to the surface as a foam. The cleaning composition may cling or adhere to the surface. The cleaning composition, and its components thereof, may mix or combine with rain. The cleaning composition may interact with the rain (e.g., to change the pH of the rain to a desirable pH, such as a “soft” pH or less acidic pH) and the cleaning composition may interact with any salt, dirt, grime, oils, and the like on the surface to lift these contaminants from the surface. The cleaning composition may create an emulsion.

The cleaning composition and contaminants may be washed away from the surface by the rain (e.g., after a certain threshold of rain or time has passed). The cleaning composition may be diluted by the rain or water as it is washed away so that it is no longer a foam. As the cleaning composition combines and mixes with the rain, the cleaning composition may significantly dissipate, dissolve, or disperse within the rain by the time it washes off of the surface onto the ground. For example, there may be little to no visual evidence of the cleaning composition or foam on the ground (or the vehicle surface) after a certain threshold of rain or time has passed.

In an embodiment, the cleaning composition may be applied to a surface when it is raining. In an embodiment, the cleaning composition may be applied to a surface so that the cleaning composition on the surface may combine with the rain as the cleaning composition is applied to a surface or just after the cleaning composition is applied to a surface. For example, a user may spray and cover a surface with the cleaning composition outside in the rain. For example, a user may spray and cover a surface with the cleaning composition inside or in a dry area (for example, a covered patio, garage, carport, or the like) and then position the surface outside in the rain (for example, moving the car from the garage where the cleaning composition was applied out to the driveway where it is raining).

In an embodiment, the cleaning composition is combined with rain before the cleaning composition has a chance to dry or while it is still a foam. For example, the cleaning composition may be combined with rain immediately or simultaneously as the cleaning composition is applied to a surface or within 5 minutes, 10 minutes, 15 minutes, etc. of being applied to a surface. The cleaning composition may combine and interact with rain to clean a surface. The cleaning composition may be washed away from the rain as the surface is being cleaned. In an embodiment, a user may supplement with tap or fresh water to wash away the cleaning composition, for example, if the rain stops before washing away all of the cleaning composition.

While many products may try to combat rain, such as preventing rain spots or preventing rain from “dirtying” a clean surface, the cleaning composition may use rain to effectuate cleaning of a surface. The cleaning composition may allow users the ability to clean their vehicles or other surfaces during rain or inclement weather when usually such weather is typically thought to prevent cleaning of these surfaces or actually “dirty” the surfaces.

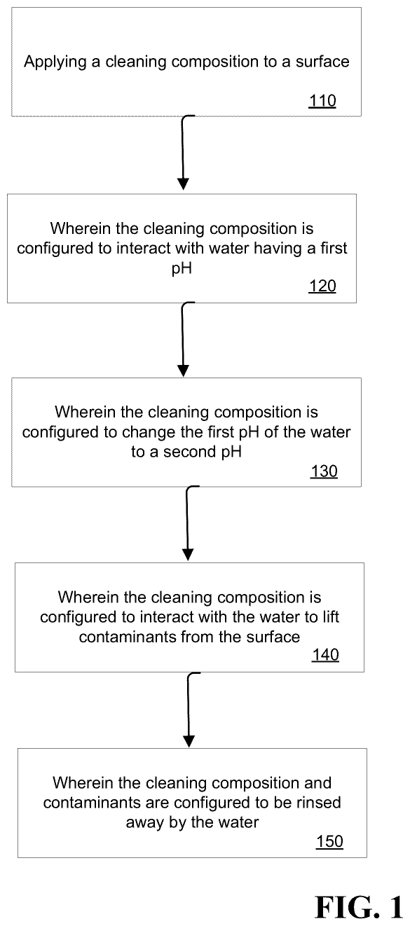

Turning to FIG. 1, shown is an example of a diagram showing an example of use of the cleaning composition. At step 110, the cleaning composition may be applied to a surface. In an embodiment, the cleaning composition may be applied to a surface as it is raining. In an embodiment, the cleaning composition may be applied to a surface just before or preceding when it is about to rain (e.g., 5 minutes, 10 minutes, 15 minutes before rain).

At step 120, the cleaning composition may be configured to interact with water (e.g., rain) having a first pH. In an embodiment, this first pH may be acidic. At step 130, the cleaning composition may be configured to change the pH of the water to a second pH (e.g., of the modified water with the cleaning composition). At step 130, the cleaning composition may be configured to raise the pH of the water to a second pH (e.g., of the modified water with the cleaning composition). In an embodiment, this second pH may be higher than the first pH. In an embodiment, this second pH may be less acidic than the first pH. In an embodiment, this second pH may be more neutral than the first pH. In an embodiment, this second pH may be more basic than the first pH. It is noted that if the pH of the water (e.g., rain) is raised when combined with the cleaning composition, that the pH of the cleaning composition may be lowered when combined with the water as a result, together forming a combined or modified water and cleaning composition mixture. In an embodiment, the second pH (e.g., of the modified water with the cleaning composition) may be “soft,” such as a pH of approximately 6 up to and including 7.

At step 140, the cleaning composition may be configured to interact with the water (e.g., rain) to lift contaminants, such as salt, dirt, grime, oils, and the like, from the surface. For example, the cleaning composition may combine with the water, change the pH of the water and resulting mixture, and attach to contaminants on the applied surface to clean the surface. At step 150, the cleaning composition and contaminants may be configured to be rinsed away by the water (e.g., rain). The cleaning composition may be rinsed away by the water with the salt, dirt, grime, oils, and the like the cleaning composition has attached to and provide a cleaned surface.

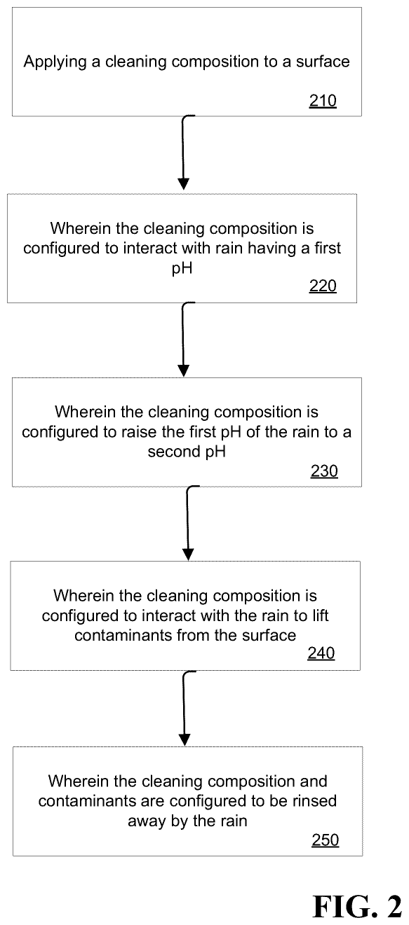

Turning to FIG. 2, shown is an example of a diagram showing an example of use of the cleaning composition. At step 210, the cleaning composition may be applied to a surface. In an embodiment, the cleaning composition may be applied to a surface as it is raining. In an embodiment, the cleaning composition may be applied to a surface just before or preceding when it is about to rain (e.g., 5 minutes, 10 minutes, 15 minutes before rain).

At step 220, the cleaning composition may be configured to interact with rain having a first pH. In an embodiment, this first pH may be acidic. At step 230, the cleaning composition may be configured to change the pH of the rain to a second pH (e.g., of the modified rain with the cleaning composition). At step 230, the cleaning composition may be configured to raise the pH of the rain to a second pH (e.g., of the modified rain with the cleaning composition). In an embodiment, this second pH may be higher than the first pH. In an embodiment, this second pH may be less acidic than the first pH. In an embodiment, this second pH may be more neutral than the first pH. In an embodiment, this second pH may be more basic than the first pH.

It is noted that if the pH of the rain is raised in combination with the cleaning composition, that the pH of the cleaning composition may be lowered in combination with the rain as a result, together forming a combined or modified rain and cleaning composition mixture. In an embodiment, the second pH (e.g., of the modified rain with the cleaning composition) may be “soft,” such as a pH of approximately 6 up to and including 7.

At step 240, the cleaning composition may be configured to interact with the rain to lift contaminants, such as salt, dirt, grime, oils, and the like, from the surface. For example, the cleaning composition may combine with the rain, change the pH of the rain and resulting mixture, and attach to contaminants on the applied surface to clean the surface. At step 250, the cleaning composition and contaminants may be configured to be rinsed away by the rain. The cleaning composition may be rinsed away by the rain with the salt, dirt, grime, oils, and the like the cleaning composition has attached to and provide a cleaned surface.

It is noted that any of the foregoing method steps may be completed in a different order than described. It is noted two or more of the described steps may happen simultaneously or near simultaneously. More that one of the steps may be considered a single step and some single steps may be considered as more than one step.

In an embodiment, the cleaning composition may be activated by rain. In an embodiment, the cleaning composition may (1) bond to salt, dirt, grime, oils, and the like, on the surface of a vehicle, for example, and (2) then wash the particles away using rain as a rinsing agent. The cleaning composition may be a basic or above neutral pH-controlled composition that can neutralize the acidity of rain to provide cleaning benefits.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

What is claimed is:

1. A cleaning composition, comprising:
a chelating agent, and
a surfactant,
wherein the cleaning composition is applicable to a surface, wherein the cleaning composition is configured to interact with water having a first pH and wherein the cleaning composition is configured to increase the first pH of the water to a second pH.

2. The cleaning composition of claim 1, wherein the water is rain.

3. The cleaning composition of claim 1, wherein the cleaning composition is configured to be used during or just preceding rain and does not require additional rinsing or water source.

4. The cleaning composition of claim 1, wherein the cleaning composition has a basic pH.

5. The cleaning composition of claim 1, wherein the cleaning composition has a neutral or basic pH.

6. The cleaning composition of claim 1, wherein the cleaning composition has a pH of 7 or greater.

7. The cleaning composition of claim 1, wherein the cleaning composition has a pH range of 7 to 7.8.

8. The cleaning composition of claim 1, wherein a pH of the cleaning composition is more basic than the first pH of the water.

9. The cleaning composition of claim 1, wherein the first pH is more acidic than the second pH.

10. The cleaning composition of claim 1, wherein the first pH is between 4 to 6.

11. The cleaning composition of claim 1, wherein the second pH is between 6 to 7.

12. The cleaning composition of claim 1, wherein the second pH has a pH of soft water.

13. The cleaning composition of claim 1 further including a foam booster.

14. The cleaning composition of claim 1 further including a purified water.

15. A rain-activated cleaning composition, comprising:
at least one chelating agent, at least one surfactant, a foam booster, and purified water;
wherein the rain-activated cleaning composition has a neutral or basic pH, wherein the rain-activated cleaning composition is configured to be applied to an exterior surface of a vehicle, wherein the rain-activated cleaning composition is configured to react with rain to clean the exterior surface of the vehicle, and wherein the rain-activated cleaning composition is configured to interact with rain to make the rain less acidic.

16. A method of using a rain-activated cleaning composition, comprising:
applying the rain-activated cleaning composition to an exterior surface;
wherein the cleaning composition is configured to interact with rain having a first pH, the cleaning composition is configured to raise the first pH of the rain to a second pH, the cleaning composition is configured to interact with the rain to lift contaminants from the surface, and wherein the cleaning composition are configured to be rinsed away by the rain with the contaminants.
